(19) United States
(12) Patent Application Publication
(10) Pub. No.: US 2016/0180470 A1
(43) Pub. Date: Jun. 23, 2016

(54) METHOD AND SYSTEM FOR EVALUATING INTERCHANGEABLE ANALYTICS MODULES USED TO PROVIDE CUSTOMIZED TAX RETURN PREPARATION INTERVIEWS

(71) Applicant: Intuit Inc., Mountain View, CA (US)

(72) Inventors: Massimo Mascaro, San Diego, CA (US); Jonathan R. Goldman, Mountain View, CA (US); Luis Felipe Cabrera, Bellevue, WA (US); William T. Laaser, Palo Alto, CA (US)

(73) Assignee: Intuit Inc., Mountain View, CA (US)

(21) Appl. No.: 14/580,416

(22) Filed: Dec. 23, 2014

(51) Int. Cl. G06Q 40/00; G06Q 10/06

(52) U.S. Cl. CPC G06Q 40/123; G06Q 10/0639

(57) ABSTRACT

A method and system evaluates analytics modules to improve a personalization of tax questions delivered to a user in a tax return preparation system, according to one embodiment. The method and system retrieves historical tax return data and selects one or more interchangeable analytics modules for evaluation with the historical tax return data, according to one embodiment. The method and system applies the historical tax return data to the one or more analytics modules that are selected for evaluation, according to one embodiment. The method and system receives analytics outputs from the one or more analytics modules, in response to applying the historical tax return data, according to one embodiment. The method and system determines an effectiveness of each of the one or more analytics modules by correlating the analytics outputs with at least part of the historical tax return data, according to one embodiment.

### BACKGROUND

Federal and State Tax law has become so complex that it is now estimated that each year Americans alone use over 6 billion person hours, and spend nearly 4 billion dollars, in an effort to comply with Federal and State Tax statutes. Given this level of complexity and cost, it is not surprising that more and more taxpayers find it necessary to obtain help, in one form or another, to prepare their taxes. Tax return preparation systems, such as tax return preparation software programs and applications, represent a potentially flexible, highly accessible, and affordable source of tax preparation assistance. However, traditional tax return preparation systems are, by design, fairly generic in nature and often lack the malleability to meet the specific needs of a given user.

For instance, traditional tax return preparation systems often present a fixed, e.g., predetermined and pre-packaged, structure or sequence of questions to all users as part of the tax return preparation interview process. Likewise, traditional tax return preparation systems often provide other user experiences associated with the tax return preparation systems, such as, but not limited to, interfaces, images, and assistance resources, in a static and generic manner to every user. This is largely due to the fact that the traditional tax return preparation system analytics used to generate a sequence of interview questions, and/or other user experiences, are static features that are typically an integral part of the tax return preparation system itself. These static features are hard-coded elements of the tax return preparation system and do not lend themselves to effective or efficient modification. As a result, using these traditional tax return preparation systems, the interview process, the user experience, and any analysis associated with the interview process and user experience, is a largely inflexible component of a given version of the tax return preparation system. Consequently, the interview processes and/or the user experience of traditional tax return preparation systems can only be modified through a redeployment of the tax return preparation system itself. Therefore, there is little or no opportunity for any analytics associated with the interview process, and/or user experience, to evolve to meet a changing situation or the particular needs of a given taxpayer, even as more information about that taxpayer, and their particular circumstances, is obtained.

As a result of the current situation described above, the use of traditional tax return preparation systems subjects virtually every user with a more or less static set of sequenced interview questions and user experience elements, regardless of the user's particular needs, assets, and economic circumstances. The sequence of questions and the user experience is pre-determined based on a generic user model that is, in fact and by design, not accurately representative of any actual “real world” user. Consequently, irrelevant, and often confusing, interview questions are virtually always presented to any given real user under this static “one size fits all” approach. It is therefore not surprising that many users, if not all users, of these traditional tax return preparation systems experience, at best, an impersonal, unnecessarily long, confusing, and complicated, interview process and user experience. Clearly, this is not the type of experience that results in satisfied, loyal, and repeat customers.

Even worse is the fact that, in many cases, the hard-coded and static analysis features associated with traditional tax return preparation systems, and the resulting presentation of irrelevant questioning and user experiences, leads potential users of traditional tax return preparation systems, i.e., potential customers, to believe that the tax return preparation system is not applicable to them, and perhaps is unable to meet their specific needs. In other cases, the users simply become frustrated with the seemingly irrelevant lines of questioning. Many of these potential users and customers then simply abandon the process and the tax return preparation systems completely, i.e., never become paying customers. Clearly, this is an undesirable result for both the potential user of the tax return preparation system and the provider of the tax return preparation system.

What is needed is a method and system for evaluating the effectiveness of dynamically and independently modifiable analytics modules in a tax return preparation system, to enable improvement of the delivery of a customized tax return interview process through a tax return preparation system.

### SUMMARY

Embodiments of the present disclosure address some of the shortcomings associated with traditional tax return preparation systems by applying historical tax return data to analytics modules to determine the effectiveness of the analytics modules for recommending particularly relevant tax questions and/or tax topics for a user. The analytics modules are interchangeable within the tax return preparation system to enable the tax return preparation system to dynamically change which algorithms, predictive models, statistical engines, or other analytical techniques to apply to user data during a tax return preparation interview, according to one embodiment. By evaluating an analytics module with historical tax return data, the tax return preparation system determines whether a particular analytics module or a particular analytics logic (e.g., predictive module) is better than another analytics module or another analytics logic, according to one embodiment. By evaluating the interchangeable analytics modules with the historical tax return data, the tax return preparation system is advantageously configurable to refine, optimize, improve, and/or modify the analytics modules so that the electronic tax return preparation interview more accurately prioritizes and sequences tax questions and/or tax topics presented to the user, according to one embodiment.

The historical tax return data includes tax return data acquired from previously completed tax returns, according to one embodiment. In one embodiment, the historical tax return data includes tax return data from users that have already completed their return in the current tax year. In one embodiment, the historical tax return data includes tax return data from one or more previous years of tax return filings. In one embodiment, the historical tax return data at least partially includes synthetic tax return data that is prepared for the evaluation of the interchangeable analytics modules. The synthetic tax return data is prepared in such a way that the relevant tax topics are known, so that the modules can be tested for accuracy in regards to predetermined or known results, according to one embodiment.

The tax return preparation system uses the historical tax return data to evaluate and compare one or more of the interchangeable analytics modules to improve the priority and/or sequence of tax topics and tax questions provided to the user by the tax return preparation system, according to one embodiment. The tax return preparation system facilitates the identification of a particularly effective, e.g., the most effective, analytics module for a particular tax question, tax topic, user, and/or set of user data, according to one embodiment. As result, the tax return preparation system enables the presentation of tax questions that are highly relevant to the user's specific situation, according to one embodiment.

In one embodiment, the tax return preparation system applies one of the interchangeable analytics modules to all or part of the historical tax return data to determine if the analytics logic of the applied interchangeable analytics module provides a better result than the analytics logic used to generate all or part of the historical tax return data.

In one embodiment, the tax return preparation system determines which of two different or competing interchangeable analytics modules provides more accurate results.

In one embodiment, the tax return preparation system is configured to generate different types of results, in response to an evaluation of an analytics module. In one embodiment, the tax return preparation system generates an evaluation score or multiple scores, in response to an evaluation of an analytics module. In one embodiment, the analytics module with the highest score is the analytics module that produces the most accurate results.

In one embodiment, the tax return preparation system evaluates one or more of the interchangeable analytics modules based on one or more specific parameters to evaluate analytics module outputs/recommendations for a particular tax question or particular condition. The tax return preparation system is configured to evaluate the analytics modules with portions of the historical tax return data, with all of the historical tax return data, or with particular tax topics or particular parameters within the historical tax return data, according to various embodiments. In one embodiment, the tax return preparation system applies analytics modules to a sample of the historical tax return data to reduce processing time associated with analyzing large quantities of data.

In one embodiment, the tax return preparation system applies the analytics modules to tax return data from other users to determine how well the analytics modules recommend relevant tax topics and tax questions for those users.

In one embodiment, the historical tax return data is modified to better match current expectations. For example, the tax return preparation system can be configured to apply inflation adjustments to wages from prior tax years.

By evaluating all or part of various analytics logic, e.g., algorithms, predictive models, and statistical engines, through the application of analytics modules to all or part of the historical tax return data, the tax return preparation system can be configured to determine which thresholds, settings, and analytics logic are most effective and can modify, update, improve, or “train” one or more of the interchangeable analytics modules, according to one embodiment. The parts of the historical tax return data used for the training may be removed for the evaluation phase, according to one embodiment.

As described above, the tax return preparation system evaluates the effectiveness of analytics modules using historical tax return data to support the use of one or more interchangeable analytics modules for individualizing the tax return preparation interview for a user. Unlike traditional tax return preparation systems, the tax return preparation system can reduce confusion, frustration, and trust issues of users by prioritizing the sequence of questions presented to the user so that more relevant questions are provided to the user and irrelevant questions are presented to the user in an optional, i.e., capable of being skipped, format, according to one embodiment. As a result, the features and techniques described herein are, in many ways, superior to the service received from a tax return specialist/preparer. For example, human error associated with a tax return specialist is eliminated, the hours of availability of the tax return specialist become irrelevant, the daily number of customers is not limited by the number of people a tax return specialist is able to visit within a 24-hour period, and the computerized tax return preparation process is unaffected by emotion, tiredness, stress, or other external factors that may be inherent in a tax return specialist during tax return season.

The various embodiments of the disclosure can be implemented to improve the technical fields of user experience, automated tax return preparation, data collection, and data processing. Therefore, the various described embodiments of the disclosure and their associated benefits amount to significantly more than an abstract idea. In particular, by evaluating and updating the interchangeable analytics modules, a tax return preparation application may be able to gather more complete information from the user and may be able to provide a more thorough and customized analysis of potential tax return benefits for the user, according to one embodiment. Furthermore, by employing an interchangeable, pluggable, and/or modular analytics module, new and/or improved versions of the analytics module may be developed and incorporated into the tax return preparation application to improve the interview process without having to rewrite, and re-test other components within the tax return preparation application, according to one embodiment.

In addition, as noted above, by minimizing, or potentially eliminating, the processing and presentation of irrelevant questions to a user, implementation of embodiments of the present disclosure allows for significant improvement to the field of data collection and data processing. As one illustrative example, by minimizing, or potentially eliminating, the processing and presentation of irrelevant question data to a user, implementation of embodiments of the present disclosure allows for relevant data collection using fewer processing cycles and less communications bandwidth. As a result, embodiments of the present disclosure allow for improved processor performance, more efficient use of memory access and data storage capabilities, reduced communication channel bandwidth utilization, and faster communications connections. Consequently, computing and communication systems implementing and/or providing the embodiments of the present disclosure are transformed into faster and more operationally efficient devices and systems.

### BRIEF DESCRIPTION OF THE DRAWINGS

FIG. 1 is a block diagram of software architecture for evaluating analytics modules to improve the personalization of tax questions delivered to a user in a tax return preparation system, in accordance with one embodiment.

FIG. 2 is a block diagram of a process for evaluating analytics modules to improve the personalization of tax questions delivered to a user in a tax return preparation system, in accordance with one embodiment.

FIG. 3 is a flow diagram for evaluating analytics modules to improve the personalization of tax questions delivered to a user in a tax return preparation system, in accordance with one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

The INTRODUCTORY SYSTEM, HARDWARE ARCHITECTURE, and PROCESS sections herein describe systems and processes suitable for applying analytics modules to historical tax return data to determine the effectiveness of the analytics modules for recommending tax questions and/or tax topics that are particularly relevant for a user, according to various embodiments.

### Introductory System

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as one or more virtual assets.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system.

As used herein, the terms “interview” and “interview process” include, but are not limited to, an electronic, software-based, and/or automated delivery of multiple questions to a user and an electronic, software-based, and/or automated receipt of responses from the user to the questions, to progress a user through one or more groups or topics of questions, according to various embodiments.

As used herein, the term “user experience” includes not only the interview process, interview process questioning, and interview process questioning sequence, but also other user experience features provided or displayed to the user such as, but not limited to, interfaces, images, assistance resources, backgrounds, avatars, highlighting mechanisms, icons, and any other features that individually, or in combination, create a user experience, as discussed herein, and/or as known in the art at the time of filing, and/or as developed after the time of filing.

### Hardware Architecture

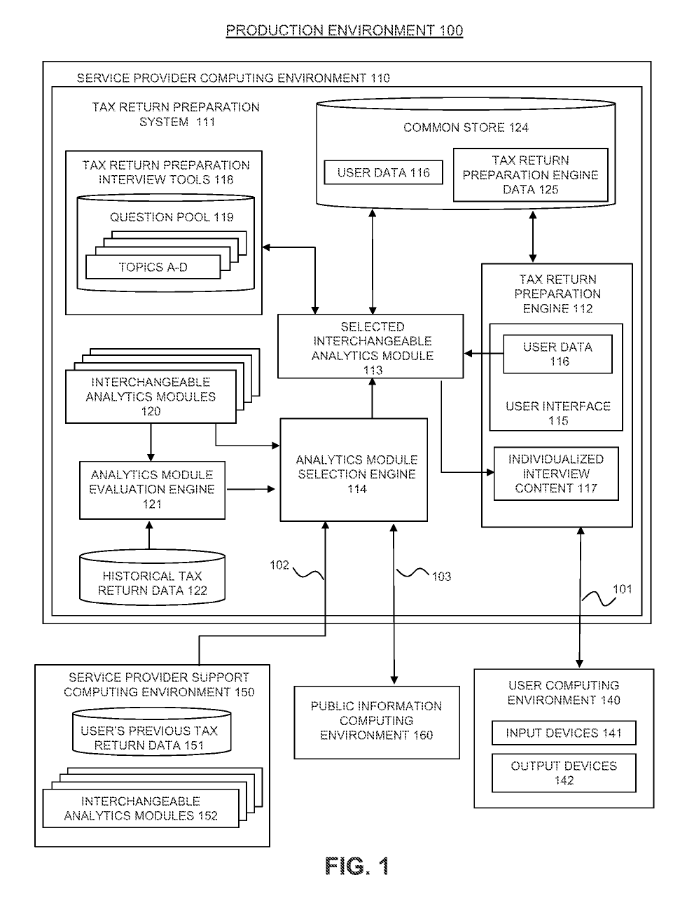

FIG. 1 illustrates a block diagram of a production environment 100 that evaluates analytics modules with historical tax return data to determine and improve the effectiveness of the analytics modules in prioritizing tax questions and/or tax topics for a user based on a tax return preparation system, according to one embodiment. The production environment 100 evaluates the analytics modules by receiving one or more analytics modules, receiving historical tax return data, applying the one or more analytics modules to the historical tax return data, comparing the evaluation results of the one or more analytics modules to the actual results within the historical tax return data, and determining the effectiveness or accuracy of the analytics modules based on the comparison between the evaluation results and the actual results, according to one embodiment. In one embodiment, one analytics module is selected for use over another analytics module, based on the effectiveness or accuracy of one analytics module over another. Various additional embodiments are disclosed below in the context of the tax return preparation system.

As discussed above, there are various long standing shortcomings associated with traditional tax return preparation systems. Because traditional programs incorporate hard-coded analytics algorithms and fixed sequences of questions, user interfaces, and other elements of the user experience, these traditional tax return preparation systems provide a tax return interview that is impersonal and that has historically been a source of confusion and frustration to a user. When using traditional tax return preparation systems, users who are confused and frustrated by irrelevant questioning, and other generic user experience features, often attempt to terminate the interview process as quickly as possible, and/or provide, unwittingly, incorrect or incomplete data. As a result, traditional tax return preparation programs may fail to generate an optimum benefit to the user, e.g., the benefit the user would be provided if the user were interviewed with more pertinent questions, in a more logical order for that user.

As one illustrative example, a single-mother that is high-school educated and who makes less than $20,000 a year is more likely to be confused by questions related to interest income, dividend income, or other investments than her counterpart who is a business executive making a six-figure income. Traditionally, a professional tax return specialist was needed to adjust the nature of questions used in an interview based on initial information received from a user. However, professional tax return specialists are expensive and less accessible than an electronic tax return preparation system, e.g., a professional tax return specialist may have hours or operate in locations that are inconvenient to some taxpayers who have inflexible work schedules.

Inefficiencies associated with updating traditional tax return preparation systems is an additional long standing shortcoming. Even if potential improvements to traditional tax return preparation systems become available, the costs associated with developing, testing, releasing, and debugging a new version of the tax return preparation system each time a new or improved analytic algorithm is discovered, or defined, will often outweigh the benefits gained by a user, or even a significant sub-set of users.

Embodiments of the present disclosure address some of the shortcomings associated with traditional tax return preparation systems by using interchangeable analytics modules to personalize the tax return interview and by applying analytics modules to historical tax return data to evaluate and improve the effectiveness of the analytics modules. The various embodiments of the disclosure can be implemented to improve the technical fields of user experience, automated tax return preparation, data collection, and data processing. Therefore, the various described embodiments of the disclosure and their associated benefits amount to significantly more than an abstract idea. In particular, by evaluating and updating the interchangeable analytics modules, a tax return preparation application may be able to gather more complete information from the user and may be able to provide a more thorough and customized analysis of potential tax return benefits for the user, according to one embodiment. Furthermore, by employing an interchangeable, pluggable, and/or modular analytics module, new and/or improved versions of the analytics module may be developed and incorporated into the tax return preparation application to improve the interview process without having to rewrite, and re-test other components within the tax return preparation application, according to one embodiment.

In addition, as noted above, by minimizing, or potentially eliminating, the processing and presentation of irrelevant questions to a user, implementation of embodiments of the present disclosure allows for significant improvement to the field of data collection and data processing. As one illustrative example, by minimizing, or potentially eliminating, the processing and presentation of irrelevant question data to a user, implementation of embodiments of the present disclosure allows for relevant data collection using fewer processing cycles and less communications bandwidth. As a result, embodiments of the present disclosure allow for improved processor performance, more efficient use of memory access and data storage capabilities, reduced communication channel bandwidth utilization, and faster communications connections. Consequently, computing and communication systems implementing and/or providing the embodiments of the present disclosure are transformed into faster and more operationally efficient devices and systems.

The production environment 100 includes a service provider computing environment 110, a user computing environment 140, a service provider support computing environment 150, and a public information computing environment 160 for applying historical tax return data to analytics modules to determine the effectiveness of the analytics modules for recommending tax questions and/or tax topics that are particularly relevant for a user, to support the operation of a tax return preparation system, according to one embodiment. The computing environments 110, 140, 150, and 160 are communicatively coupled to each other with a communication channel 101, a communication channel 102, and a communication channel 103, according to one embodiment.

The service provider computing environment 110 represents one or more computing systems such as a server, a computing cabinet, and/or distribution center that is configured to receive, execute, and host one or more tax return preparation systems (e.g., applications) for access by one or more users, e.g., tax filers and/or system administrators, according to one embodiment.

The service provider computing environment 110 includes a tax return preparation system 111 that is configured to apply analytics modules to historic or synthetic tax return data to evaluate the effectiveness of the analytics modules for recommending tax questions and/or tax topics that are particularly relevant for a user, to support the tax return preparation system 111, according to one embodiment. The tax return preparation system 111 is also configured to apply analytics modules (e.g., interchangeable analytics modules) to user data, to personalize the tax return preparation interview, according to one embodiment. The tax return preparation system 111 includes various components, databases, engines, modules, and/or data to support the evaluation, selection, and application of interchangeable analytics modules, according to various embodiments.

Hereafter, the present disclosure describes an architecture of the tax return preparation interview features, describes an architecture of the analytic module evaluation features, and then describes an embodiment of an interaction between the analytic module evaluation features and the tax return preparation interview features within the tax return preparation system 111, in accordance with embodiments of the disclosure.

The tax return preparation system 111 includes a tax return preparation engine 112, a selected interchangeable analytics module 113, and an analytics module selection engine 114, configured to apply an interchangeable analytics module to user data to provide tax questions to the user in a sequence that is relevant to the user, according to one embodiment.

The tax return preparation engine 112 guides the user through the tax return preparation process by presenting the user with interview content, such as a sequence of interview questions, tax topics, and other user experience features, according to one embodiment. The tax return preparation engine 112 includes a user interface 115 to receive user data 116 from the user and to present customized interview content 117 to the user, according to one embodiment. The user interface 115 includes one or more user experience elements and graphical user interface tools, such as, but not limited to, buttons, slides, dialog boxes, text boxes, drop-down menus, banners, tabs, directory trees, links, audio content, video content, and/or other multimedia content for communicating information to the user and for receiving the user data 116 from the user, according to one embodiment. The tax return preparation engine 112 employs the user interface 115 to receive the user data 116 from input devices 141 of the user computing environment 140 and employs the user interface 115 to transmit the customized interview content 117 (inclusive of various user experience elements) to output devices 142 of the user computing environment 140, according to one embodiment.

The tax return preparation engine 112 can be configured to synchronously or asynchronously retrieve, apply, and present the customized interview content 117, according to various embodiments. For example, the tax return preparation engine 112 can be configured to wait to receive the customized interview content 117 from the selected interchangeable analytics module 113 before continuing to query or communicate with a user regarding additional information or regarding topics from the question pool 119, according to one embodiment. The tax return preparation engine 112 can alternatively be configured to submit user data 116 to the selected interchangeable analytics module 113 or submit another request to the selected interchangeable analytics module 113 and concurrently continue functioning/operating without waiting for a response from the selected interchangeable analytics module 113, according to one embodiment.

The user data 116 includes information collected directly and/or indirectly from the user, according to one embodiment. The user data 116 includes information, such as, but not limited to, a name, a Social Security number, a government identification, a driver's license number, a date of birth, an address, a zip code, home ownership status, marital status, annual income, W-2 income, a job title, an employer's address, spousal information, children's information, asset information, medical history, occupation, website browsing preferences, a typical lingering duration on a website, information regarding dependents, salary and wages, interest income, dividend income, business income, farm income, capital gain income, pension income, IRA distributions, unemployment compensation, education expenses, health savings account deductions, moving expenses, IRA deductions, student loan interest deductions, tuition and fees, medical and dental expenses, state and local taxes, real estate taxes, personal property tax, mortgage interest, charitable contributions, casualty and theft losses, unreimbursed employee expenses, alternative minimum tax, foreign tax credit, education tax credits, retirement savings contribution, child tax credits, residential energy credits, and any other information that is currently used, that can be used, or that may be used in the future, for the electronic preparation of a user's tax return, according to various embodiments. The user data 116 also includes mouse-over information, durations for entering responses to questions, and other clickstream information, according to one embodiment. In some implementations, the user data 116 is a subset of all of the user information used by the tax return preparation system 111 to prepare the user's tax return, e.g., is limited to marital status, children's information, and annual income.

In some embodiments, at least part of the user data 116 is acquired from sources that are external to the tax return preparation system 111. For example, the user data 116 can include the user's previous tax return data 151 or information gathered from the public information computing environment 160, such as, but not limited to, real estate values, social media, financial history, and internet clickstream data, according to one embodiment.

The selected interchangeable analytics module 113 applies one or more algorithms, predictive models, statistical engines, or analysis techniques to the user data 116 to generate a sequence or priority of interview questions and/or tax topics into the interview content 117, which is personalized to each user. The selected interchangeable analytics module 113 is configured to generate the individualized interview content 117 (e.g., the sequence of tax questions or tax topics) at least partially based on the tax return preparation interview tools 118, which includes a question pool 119 of various tax topics, e.g., topics A-D, according to one embodiment. The selected interchangeable analytics module 113 receives the user data 116 from the tax return preparation engine 112, analyzes the user data 116, and generates the customized interview content 117 based on the user data 116 and based on the particular algorithm, predictive model, statistical engine, or analysis technique used by the selected interchangeable analytics module 113, according to one embodiment. The selected interchangeable analytics module 113 is an interchangeable component/module within the tax return preparation system 111, according to one embodiment. In other words, the selected interchangeable analytics module 113 can be modified, overwritten, deleted and/or conveniently replaced/updated with different and/or improved analytics modules, by the analytics module selection engine 114, without requiring modification to other components within the tax return preparation system 111, according to one embodiment. An advantage of implementing the selected interchangeable analytics module 113 as an interchangeable or pluggable module/component is that while one version of the selected interchangeable analytics module 113 is being executed, improved versions, i.e., other analytics modules, such as the interchangeable analytics modules 153 of service provider support computing environment 150, can be developed and tested. One or more of the other interchangeable analytics modules 120 and 152 can then be made available to the tax return preparation engine 112 without making changes to the tax return preparation engine 112, or other components within the tax return preparation system 111, according to one embodiment.

The interview content 117 is received from the selected interchangeable analytics module 113 after the selected interchangeable analytics module 113 analyzes the user data 116, according to one embodiment. The interview content 117 can include, but is not limited to, a sequence with which interview questions are presented, the content/topics of the interview questions that are presented, the font sizes used while presenting information to the user, the length of descriptions provided to the user, themes presented during the interview process, the types of icons displayed to the user, the type of interface format presented to the user, images displayed to the user, assistance resources listed and/or recommended to the user, backgrounds presented, avatars presented to the user, highlighting mechanisms used and highlighted features, and any other features that individually, or in combination, create a user experience, as discussed herein, and/or as known in the art at the time of filing, and/or as developed after the time of filing, that are displayed in, or as part of, the user interface 115 to acquire information from the user, the length of descriptions provided to the user, themes presented during the interview process, and/or the type of user assistance offered to the user during the interview process, according to various embodiments.

The analytics module selection engine 114 executes the selection, interface, and exchange, of the interchangeable analytics modules 113, 120, and 152 within the tax return preparation system, without requiring the redeployment of either the tax return preparation system or any individual analytics module, according to one embodiment. The analytics module selection engine 114 is capable of interchanging different analytics modules 113, 120, and 152 within the tax return preparation system 111 to advantageously evaluate the attributes and characteristics of a user's filing and customize the tax return preparation interview based on the individual, similar to the approach of a human tax return preparation specialist, according to one embodiment. The interchangeable analytics modules 113, 120, and 152 include one or more algorithms, predictive models, analytic engines, and processes to support the customization of the tax return preparation interviews, according to one embodiment. For example, each of the interchangeable analytics modules 113, 120, and 152 can be configured to use a particular algorithm, model, or analytic for customizing one or more of: a prioritization of tax topics, a prioritization of tax return interview questions, tax return interview question sequences, user interfaces, images, user recommendations, and supplemental actions and recommendations.

The tax return preparation system 111 addresses some of the shortcomings associated with traditional tax return preparation systems by applying one or more of the interchangeable analytics modules 113, 120, and 152 to historical or synthetic tax return data to determine the effectiveness of the interchangeable analytics modules for recommending tax questions and/or tax topics that are particularly relevant for a user, according to one embodiment. In particular, the tax return preparation system 111 includes an analytics module evaluation engine 121 that is configured to evaluate the effectiveness of one or more of the interchangeable analytics modules 113, 120, and 152, by applying the algorithm, predictive module, statistical engine, or other analytics logic of the one or more interchangeable analytics modules 113, 120, and 152 to historical tax return data 122, according to one embodiment. By evaluating an analytics module with historical tax return data, the tax return preparation system determines whether a particular analytics module or a particular analytics logic (e.g., predictive module) is better than another analytics module or another analytics logic, according to one embodiment. By evaluating the interchangeable analytics modules 113, 120, and 152 with the historical tax return data 122, the tax return preparation system 111 is advantageously configurable to refine, optimize, improve, and/or modify the analytics modules so that the electronic tax return preparation interview more accurately prioritizes and sequences tax questions and/or tax topics presented to the user, according to one embodiment.

The historical tax return data 122 includes tax return data acquired from previously completed tax returns, according to one embodiment. In one embodiment, the historical tax return data 122 includes tax return data from users that have already completed their return in the current tax year. In one embodiment, the historical tax return data 122 includes tax return data from one or more previous years of tax return filings. In one embodiment, the historical tax return data 122 at least partially includes synthetic tax return data that is prepared for the evaluation of the interchangeable analytics modules. The synthetic tax return data is prepared in such a way that the relevant tax topics are known, so that the modules can be tested for accuracy in regards to predetermined or known results, according to one embodiment. In one embodiment, the historical tax return data 122 is stored in a computing environment, e.g., service provider support computing environment 150, which is different than the computing environment, e.g., the service provider computing environment 110, which hosts the tax return preparation system 111. The historical tax return data 122 includes information, such as, but not limited to, a name, a Social Security number, a government identification, a driver's license number, a date of birth, an address, a zip code, home ownership status, a marital status, an annual income, a W-2 income, a job title, an employer's address, spousal information, children's information, asset information, medical history, occupation, website browsing preferences, a typical lingering duration on a website, information regarding dependents, salary and wages, interest income, dividend income, business income, farm income, capital gain income, pension income, IRA distributions, unemployment compensation, education expenses, health savings account deductions, moving expenses, IRA deductions, student loan interest deductions, tuition and fees, medical and dental expenses, state and local taxes, real estate taxes, personal property tax, mortgage interest, charitable contributions, casualty and theft losses, unreimbursed employee expenses, alternative minimum tax, foreign tax credit, education tax credits, retirement savings contribution, child tax credits, residential energy credits, 1099 form information, K-1 form information, and any other information that is currently used, that can be used, or that may be used in the future, for the electronic preparation of a user's tax return, according to various embodiments.

The analytics module evaluation engine 121 uses the historical tax return data 122 to evaluate and compare one or more of the interchangeable analytics modules 113, 120, and 152 to improve the priority and/or sequence of tax topics and tax questions provided to the user by the tax return preparation system 111, according to one embodiment. The analytics module evaluation engine 121 facilitates the identification of a particularly effective, e.g., the most effective, analytics module for a particular tax question, tax topic, user, and/or set of user data, according to one embodiment. The analytics module evaluation engine 121 determines the accuracy or effectiveness of the an analytics module by comparing the analytics output from the analytics module to the data points within the historical tax return data, according to one embodiment. The analytics module evaluation engine 121 compares the analytics output with the historical tax return data to determine true positives, true negatives, false positives, and false negatives from the determinations made by the interchangeable analytics module 113, 120, or 152, according to one embodiment. By comparing the analytics output with actual samples, the analytics module evaluation engine 121 can determine how accurately the analytics module can predict the relevance of a tax question to a user, according to one embodiment. As result, the analytics module evaluation engine 121 enables the tax return preparation system 111 to present tax questions to a user that are highly relevant to the user's specific situation, according to one embodiment.

In one embodiment, the analytics module evaluation engine 121 applies one of the interchangeable analytics modules 113, 120, and 152 to all or part of the historical tax return data 122 to determine if the analytics logic of the applied interchangeable analytics module provides a better result than the analytics logic used to generate all or part of the historical tax return data 122.

In one embodiment, the analytics module evaluation engine 121 determines which of two different or competing interchangeable analytics modules provides more accurate results. For example, the analytics module evaluation engine 121 can apply the selected interchangeable analytics module 113 and one of the interchangeable analytics modules 120 to all or part of the historical tax return data 122 to compare the results of the analytics modules.

In one embodiment, the analytics module evaluation engine 121 is configured to generate different types of results, in response to an evaluation of an analytics module. In one embodiment, the analytics module evaluation engine 121 generates an evaluation score or multiple scores, in response to an evaluation of an analytics module. In one embodiment, the analytics module with the highest score is the analytics module that produces the most accurate results. In one embodiment, the analytics module evaluation engine 121 generates a binary, e.g., higher and lower, evaluation result for the evaluated analytics modules. In one embodiment, the analytics module evaluation engine 121 ranks the evaluated analytics modules from most accurate to least accurate.

In one embodiment, the analytics module evaluation engine 121 evaluates one or more of the interchangeable analytics modules 113, 120, and 152 based on one or more specific parameters to evaluate analytics module outputs/recommendations for a particular tax question or particular condition. For example, the analytics module evaluation engine 121 can be configured to apply a W-2 income amount or a zip code to the evaluated analytics modules to determine when the analytics modules will recommend adding a tax question regarding dividend income. The analytics module evaluation engine 121 can be configured to subsequently compare the recommendations of the analytics modules against whether users actually needed a particular tax question, e.g., questions regarding dividend income, to determine the accuracy of the evaluated analytics modules, according to one embodiment. The analytics module evaluation engine 121 is configured to evaluate the analytics modules with portions of the historical tax return data 122, with all of the historical tax return data 122, or with particular tax topics or particular parameters within the historical tax return data 122, according to various embodiments. In one embodiment, the analytics module evaluation engine 121 applies analytics modules to a sample of the historical tax return data 122 to reduce processing time associated with analyzing large quantities of data.

In one embodiment, the analytics module evaluation engine 121 applies the analytics modules to tax return data from other users to determine how well the analytics modules recommend tax topics and tax questions for those users.

In one embodiment, the historical tax return data 122 is modified to better match current expectations. For example, the tax return preparation system 111 can be configured to apply inflation adjustments to wages from prior tax years.

By evaluating all or part of various analytics logic, e.g., algorithms, predictive models, and statistical engines, through the application of analytics modules to all or part of the historical tax return data 122, the analytics module evaluation engine 121 can be configured to determine which thresholds, settings, and analytics logic are most effective and can modify, update, improve, or “train” one or more of the interchangeable analytics modules 113, 120, and 152, according to one embodiment. The parts of the historical tax return data 122 used for the training may be removed for the evaluation phase, according to one embodiment.

In one embodiment, the analytics module evaluation engine 121 and the historical tax return data 122 are hosted separately from the remainder of the tax return preparation system 111, so that the effectiveness of analytics modules can be tested independently from progressing a user through a tax return preparation interview. In other embodiments, the analytics module engine 121 is integrated in the tax return preparation system 111 to periodically or continuously evaluate the analytics modules that are in use by the tax return preparation system 111. For example, the analytics module evaluation engine 121 can be configured to perform real-time analyses on analytics modules during the tax return preparation interview and can provide recommendations for analytics modules to the analytics module selection engine 114, according to one embodiment.

According to one embodiment, the components within the tax return preparation system 111 communicate with each other using API functions, routines, and/or calls. However, according to another embodiment, the selected interchangeable analytics module 113, the tax return preparation engine 112, and other functional modules/components can use a common store 124 for sharing, communicating, or otherwise delivering information between different features or components within the tax return preparation system 111. The common store 124 includes, but is not limited to, the user data 116 and tax return preparation engine data 125, according to one embodiment. The selected interchangeable analytics module 113 can be configured to store information and retrieve information from the common store 124 independent of information retrieved from and stored to the common store 124 by the tax return preparation engine 112, according to one embodiment. In addition to the selected interchangeable analytics module 113 and the tax return preparation engine 112, other components within the tax return preparation system 111 and other computer environments may be granted access to the common store 124 to facilitate communications with the selected interchangeable analytics module 113 and/or the tax return preparation engine 112, according to one embodiment.

As described above, the production environment 100 evaluates the effectiveness of analytics modules using historical tax return data to support the use of one or more interchangeable analytics modules for individualizing the tax return preparation interview for a user. Unlike traditional tax return preparation systems, the tax return preparation system 111 can reduce confusion, frustration, and trust issues of users by prioritizing the sequence of questions presented to the user so that more relevant questions are provided to the user and irrelevant questions are presented to the user in an optional, i.e., capable of being skipped, format, according to one embodiment. As a result, the features and techniques described herein are, in many ways, superior to the service received from a tax return specialist/preparer. For example, human error associated with a tax return specialist is eliminated, the hours of availability of the tax return specialist become irrelevant, the daily number of customers is not limited by the number of people a tax return specialist is able to visit within a daily basis, and the computerized tax return preparation process is unaffected by emotion, tiredness, stress, or other external factors that may be inherent in a tax return specialist during tax return season.

The various embodiments of the disclosure can be implemented to improve the technical fields of user experience, automated tax return preparation, data collection, and data processing. Therefore, the various described embodiments of the disclosure and their associated benefits amount to significantly more than an abstract idea. In particular, by evaluating and updating the interchangeable analytics modules, a tax return preparation application may be able to gather more complete information from the user and may be able to provide a more thorough and customized analysis of potential tax return benefits for the user, according to one embodiment. Furthermore, by employing an interchangeable, pluggable, and/or modular analytics module, new and/or improved versions of the analytics module may be developed and incorporated into the tax return preparation application to improve the interview process without having to rewrite, and re-test other components within the tax return preparation application, according to one embodiment.

In addition, as noted above, by minimizing, or potentially eliminating, the processing and presentation of irrelevant questions to a user, implementation of embodiments of the present disclosure allows for significant improvement to the field of data collection and data processing. As one illustrative example, by minimizing, or potentially eliminating, the processing and presentation of irrelevant question data to a user, implementation of embodiments of the present disclosure allows for relevant data collection using fewer processing cycles and less communications bandwidth. As a result, embodiments of the present disclosure allow for improved processor performance, more efficient use of memory access and data storage capabilities, reduced communication channel bandwidth utilization, and faster communications connections. Consequently, computing and communication systems implementing and/or providing the embodiments of the present disclosure are transformed into faster and more operationally efficient devices and systems.

### Process

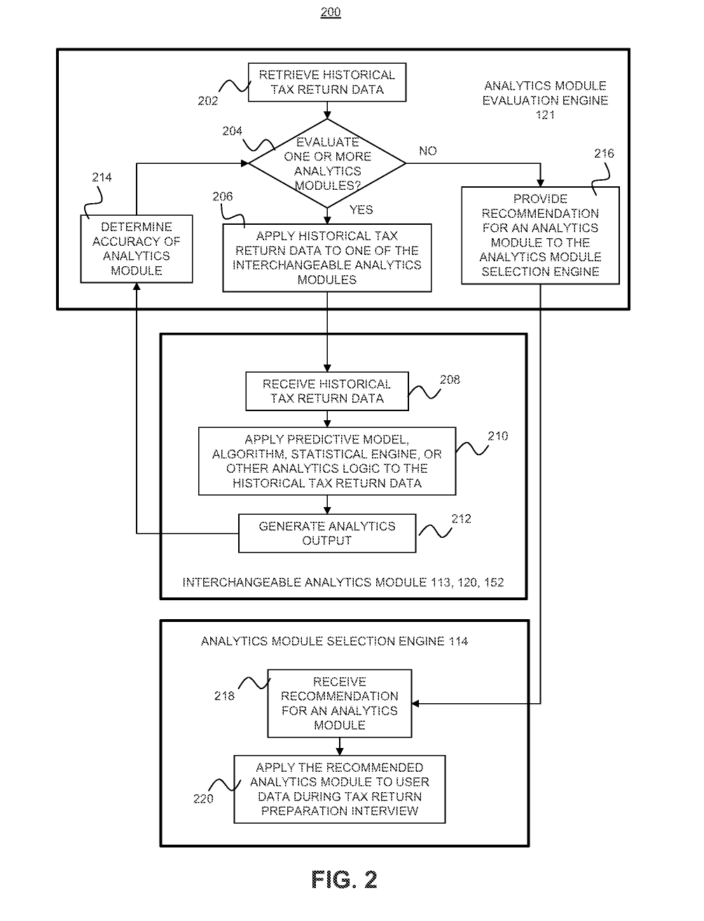

FIG. 2 illustrates a functional flow diagram of a process 200 for evaluating analytics modules with historical tax return data to determine and improve the effectiveness of the analytics modules, according to one embodiment.

At block 202, the analytics module evaluation engine retrieves historical tax return data, according to one embodiment. As described above, the historical tax return data includes, but is not limited to, tax return data from tax returns that have been completed in the current year, tax return data from tax returns that have been completed in one or more previous years, samples or portions of tax return data from one or more previous years, inflation-adjusted tax return data from one or more previous years, and synthetic tax return data, according to various embodiments.

At block 204, the analytics module evaluation engine 121 determines whether to evaluate one or more analytics modules, according to one embodiment. For example, the analytics module evaluation engine 121 can be configured to evaluate two different analytics modules that perform the same function by using different techniques, to determine which analytics module is more accurate or effective in predicting tax questions or tax topics that are relevant to the user, according to one embodiment. If the analytics module evaluation engine 121 will evaluate an additional analytics module, the process 200 proceeds to block 206, according to one embodiment.

At block 206, the analytics module evaluation engine 121 applies historical tax return data to one of the interchangeable analytics modules, according to one embodiment.

At block 208, an interchangeable analytics module 113, 120, or 152 receives historical tax return data, according to one embodiment.

At block 210, the interchangeable analytics module 113, 120, or 152 applies a predictive model, an algorithm, a statistical engine, or other analytics logic to historical tax return data, according to one embodiment.

At block 212, the interchangeable analytics module 113, 120, or 152, generates analytics output, according to one embodiment. The analytics output can be Boolean (e.g., YES or NO), can be numeric (e.g., on a scale of 1 to 10), can reference a particular recommended tax question (e.g., a dividend income tax question), or the like, according to various embodiments.

At block 214, the analytics module evaluation engine 121 determines the accuracy of the analytics module, according to one embodiment. The analytics module evaluation engine 121 determines the accuracy or effectiveness of an analytics module by comparing the analytics output from the analytics module to the data points within the historical tax return data, according to one embodiment. The analytics module evaluation engine 121 compares the analytics output with the historical tax return data to determine true positives, true negatives, false positives, and false negatives from the determinations made by the interchangeable analytics module 113, 120, or 152, according to one embodiment. By comparing the analytics output with actual samples, the analytics module evaluation engine 121 can determine how accurately the analytics module can predict the relevance of a tax question to a user, according to one embodiment.

The process 200 returns to block 204 to determine whether to evaluate an additional analytics module, according to one embodiment. If an additional analytics module is evaluated, the process 200 proceeds to block 206, according to one embodiment. If further analytics modules are not evaluated, the process 200 proceeds to block 216, according to one embodiment.

At block 216, the analytics module evaluation engine 121 provides a recommendation for an analytics module to the analytics module selection engine, according to one embodiment.

At block 218, the analytics module selection engine 114 receives the recommendation for an analytics module, according to one embodiment.

At block 220, the analytics module selection engine 114 applies the recommended analytics module to user data during a tax return preparation interview, according to one embodiment.

Although a particular sequence is described herein for the execution of the process 200, other sequences can also be implemented, according to other embodiments.

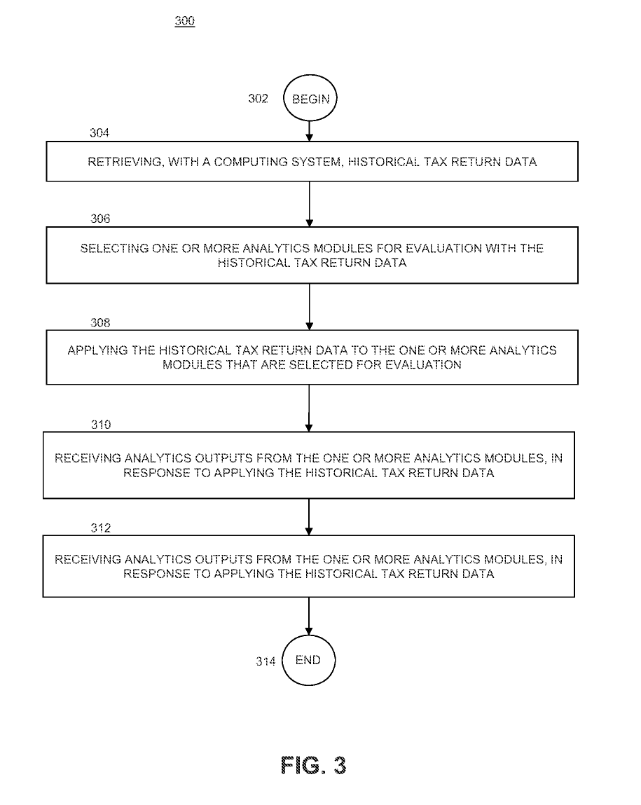

FIG. 3 illustrates a flow diagram of a process 300 for evaluating analytics modules to improve a personalization of tax questions delivered to a user in a tax return preparation system, according to various embodiments.

At block 302, the process begins.

At block 304, the process retrieves, with a computing system, historical tax return data, according to one embodiment.

At block 306, the process selects one or more analytics modules for evaluation with the historical tax return data, according to one embodiment. Each of the one or more analytics modules are interchangeably pluggable into the tax return preparation system, according to one embodiment.

At block 308, the process applies the historical tax return data to the one or more analytics modules that are selected for evaluation, according to one embodiment.

At block 310, the process receives analytics outputs from the one or more analytics modules, in response to applying the historical tax return data, according to one embodiment.

At block 312, the process determines an effectiveness of each of the one or more analytics modules by correlating the analytics outputs with at least part of the historical tax return data, according to one embodiment.

At block 314, the process ends.

As noted above, the specific illustrative examples discussed above are but illustrative examples of implementations of embodiments of the method or process for individualizing the tax return preparation interview with an interchangeable, e.g., modular, analytics module. Those of skill in the art will readily recognize that other implementations and embodiments are possible. Therefore the discussion above should not be construed as a limitation on the claims provided below.

In accordance with an embodiment, a computing system implemented method for evaluates analytics modules to improve a personalization of tax questions delivered to a user in a tax return preparation system. The method retrieves, with a computing system, historical tax return data, according to one embodiment. The method selects one or more analytics modules for evaluation with the historical tax return data, according to one embodiment. Each of the one or more analytics modules are interchangeably pluggable into the tax return preparation system, according to one embodiment. The method applies the historical tax return data to the one or more analytics modules that are selected for evaluation, according to one embodiment. The method receives analytics outputs from the one or more analytics modules, in response to applying the historical tax return data, according to one embodiment. The method determining an effectiveness of each of the one or more analytics modules by correlating the analytics outputs with at least part of the historical tax return data, according to one embodiment.

In accordance with an embodiment, a computer-readable medium has a plurality of computer-executable instructions which, when executed by a processor, perform a method for evaluating interchangeable analytics modules to improve a personalization of tax questions delivered to a user in a tax return preparation system. The instructions includes a data structure storing historical tax return data and one or more interchangeable analytics modules, according to one embodiment. Each of the one or more interchangeable analytics modules is configured to apply a data evaluation model to tax return data to generate an analytics output, and the analytics output is associated with prioritizing tax questions for a tax return preparation interview, according to one embodiment. The instructions include an analytics module evaluation engine configured to apply the one or more interchangeable analytics modules to the historical tax return data to generate analytics outputs, according to one embodiment. The analytics module evaluation engine compares the analytics outputs to the historical tax return data to determine a quantity of correlation between the analytics outputs and the historical tax return data, according to one embodiment. A higher correlation between one of the analytics outputs and the historical tax return data is associated with a higher predictive accuracy, and the analytics module evaluation engine prioritizes the one or more interchangeable analytics modules based on the quantity of correlation between the analytics outputs and the historical tax return data, according to one embodiment.

In accordance with one embodiment, a system for evaluates analytics modules to improve a personalization of tax questions delivered to a user in a tax return preparation system. The system includes at least one processor and at least one memory coupled to the at least one processor, according to one embodiment. The at least one memory stores instructions which, when executed by any set of the one or more processors, perform a process for evaluating analytics modules to improve a personalization of tax questions delivered to a user in a tax return preparation system, according to one embodiment. The process retrieves, with a computing system, historical tax return data, according to one embodiment. The process selects one or more analytics modules for evaluation with the historical tax return data, according to one embodiment. Each of the one or more analytics modules are interchangeably pluggable into the tax return preparation system, according to one embodiment. The process applies the historical tax return data to the one or more analytics modules that are selected for evaluation, according to one embodiment. The process receives analytics outputs from the one or more analytics modules, in response to applying the historical tax return data, according to one embodiment. The process determines an effectiveness of each of the one or more analytics modules by correlating the analytics outputs with at least part of the historical tax return data, according to one embodiment.

By minimizing, or potentially eliminating, the processing and presentation of irrelevant questions and/or other user experience elements to a user, implementation of embodiments of the present disclosure allows for significant improvement to the technical fields of user experience, electronic tax return preparation, data collection, and data processing. As one illustrative example, by minimizing, or potentially eliminating, the processing and presentation of irrelevant question data to a user, implementation of embodiments of the present disclosure use fewer human resources (e.g., time, focus) by not asking irrelevant questions and allows for relevant data collection by using fewer processing cycles and less communications bandwidth. As a result, embodiments of the present disclosure allow for improved processor performance, more efficient use of memory access and data storage capabilities, reduced communication channel bandwidth utilization, faster communications connections, and improved user efficiency. Consequently, computing and communication systems are transformed into faster and more operationally efficient devices and systems by implementing and/or providing the embodiments of the present disclosure. Therefore, implementation of embodiments of the present disclosure amount to significantly more than an abstract idea and also provide several improvements to multiple technical fields.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG. s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for evaluating analytics modules to improve a personalization of tax questions delivered to a user in a tax return preparation system, comprising:
retrieving, with a computing system, historical tax return data;
selecting one or more analytics modules for evaluation with the historical tax return data,
wherein each of the one or more analytics modules are interchangeably pluggable into the tax return preparation system;
applying the historical tax return data to the one or more analytics modules that are selected for evaluation;
receiving analytics outputs from the one or more analytics modules, in response to applying the historical tax return data; and
determining an effectiveness of each of the one or more analytics modules by correlating the analytics outputs with at least part of the historical tax return data.

2. The method of claim 1, further comprising:
sorting the one or more analytics modules based on the effectiveness of each of the one or more analytics modules; and
providing, for use within the tax return preparation system, one of the one or more analytics modules having a highest effectiveness.

3. The method of claim 1, wherein the effectiveness of each of the one or more analytics modules is associated with a numerical effectiveness score.

4. The method of claim 1, wherein the historical tax return data includes one or more of:
data indicating the user's name;
data indicating the user's Social Security Number;
data indicating the user's government identification;
data indicating the user's a driver's license number;
data indicating the user's date of birth;
data indicating the user's address;
data indicating the user's zip code;
data indicating the user's home ownership status;
data indicating the user's marital status;
data indicating the user's annual income;
data indicating the user's job title;
data indicating the user's employer's address;
data indicating the user's spousal information;
data indicating the user's children's information;
data indicating the user's assets;
data indicating the user's medical history;
data indicating the user's occupation;
data indicating the user's website browsing preferences;
data indicating the user's typical lingering duration on a website;
data indicating the user's dependents;
data indicating the user's salary and wages;
data indicating the user's interest income;
data indicating the user's dividend income;
data indicating the user's business income;
data indicating the user's farm income;
data indicating the user's capital gain income;
data indicating the user's pension income;
data indicating the user's IRA distributions;
data indicating the user's unemployment compensation;
data indicating the user's educator expenses;
data indicating the user's health savings account deductions;
data indicating the user's moving expenses;
data indicating the user's IRA deductions;
data indicating the user's student loan interest deductions;
data indicating the user's tuition and fees;
data indicating the user's medical and dental expenses;
data indicating the user's state and local taxes;
data indicating the user's real estate taxes;
data indicating the user's personal property tax;
data indicating the user's mortgage interest;
data indicating the user's charitable contributions;
data indicating the user's casualty and theft losses;
data indicating the user's unreimbursed employee expenses;
data indicating the user's alternative minimum tax;
data indicating the user's foreign tax credit;
data indicating the user's education tax credits;
data indicating the user's retirement savings contribution;
data indicating the user's child tax credits;
data indicating the user's residential energy credits;
data from the user's 1099 form; and
data from the user's K-1 form.

5. The method of claim 1, further comprising:
receiving, with the computing system, user data from the user through a user interface; and
applying a selected one of the one or more analytics modules to the user data to determine a relevance of tax questions to the user,
wherein the selected one of the one or more analytics modules includes a higher effectiveness than another of the one or more analytics modules.

6. The method of claim 1, wherein selecting one or more analytics modules for evaluation includes selecting two analytics modules that are configured to perform a particular function, with two different techniques, to determine which of the two analytics modules more accurately prioritizes tax questions for the user.

7. The method of claim 1, wherein the historical tax return data includes tax return data for other users from a present tax year.

8. The method of claim 1, wherein the historical tax return data includes tax return data for other users from one or more previous tax years.

9. The method of claim 1, wherein the historical tax return data includes synthetic data that has been prepared for the evaluation of the one or more analytics modules.

10. The method of claim 1, wherein the one or more analytics modules are configured to prioritize tax questions and tax topics based on user data.

11. The method of claim 1, wherein the tax return preparation system applies at least some of the one or more analytics modules to user data received from the user during a tax return preparation interview.

12. The method of claim 1, wherein applying the historical tax return data includes applying a sample of the historical tax return data to the one or more analytics modules, to limit evaluation time for the one or more analytics modules.

13. The method of claim 1, wherein applying the historical tax return data to the one or more analytics modules includes applying one or more specific parameters of the historical tax return data to determine the analytics outputs for a particular tax question.

14. The method of claim 1, wherein the historical tax return data includes inflation adjustments so that the historical tax return data corresponds to present currency values.

15. The method of claim 1, wherein each of the one or more analytics modules includes at least one of an algorithm, a predictive model, and a statistical engine.

16. The method of claim 1, further comprising:
training one or more of the analytics modules based at least partially on the determined effectiveness of each of the analytics modules.

17. A computer-readable medium having a plurality of computer-executable instructions which, when executed by a processor, perform a method for evaluating interchangeable analytics modules to improve a personalization of tax questions delivered to a user in a tax return preparation system, the instructions comprising:
a data structure storing historical tax return data;
one or more interchangeable analytics modules,
wherein each of the one or more interchangeable analytics modules is configured to apply a data evaluation model to tax return data to generate an analytics output,
wherein the analytics output is associated with prioritizing tax questions for a tax return preparation interview; and
an analytics module evaluation engine configured to apply the one or more interchangeable analytics modules to the historical tax return data to generate analytics outputs,
wherein the analytics module evaluation engine compares the analytics outputs to the historical tax return data to determine a quantity of correlation between the analytics outputs and the historical tax return data,
wherein a higher correlation between one of the analytics outputs and the historical tax return data is associated with a higher predictive accuracy,
wherein the analytics module evaluation engine prioritizes the one or more interchangeable analytics modules based on the quantity of correlation between the analytics outputs and the historical tax return data.

18. The computer-readable medium of claim 17, wherein the instructions further comprise an analytics module configured to receive a recommendation for one of the interchangeable analytics modules from the analytics module evaluation engine, at least partially based on prioritizations of the one or more interchangeable analytics modules by the analytics module evaluation engine.

19. The computer-readable medium of claim 17, wherein the historical tax return data includes tax return data for other users from a present tax year.

20. The computer-readable medium of claim 17, wherein the historical tax return data includes tax return data for other users from one or more previous tax years.

21. The computer-readable medium of claim 17, wherein the analytics module evaluation engine is configured to apply the one or more interchangeable analytics modules to one or more specific parameters of the historical tax return data to determine the analytics outputs for a particular tax question.

22. The computer-readable medium of claim 17, wherein each of the one or more interchangeable analytics modules includes at least one of an algorithm, a predictive model, and a statistical engine.

23. A system for evaluating analytics modules to improve a personalization of tax questions delivered to a user in a tax return preparation system, the system comprising:
at least one processor; and
at least one memory coupled to the at least one processor, the at least one memory having stored therein instructions which, when executed by any set of the one or more processors, perform a process for evaluating analytics modules to improve a personalization of tax questions delivered to a user in a tax return preparation system, the process including:
retrieving, with a computing system, historical tax return data;
selecting one or more analytics modules for evaluation with the historical tax return data,
wherein each of the one or more analytics modules are interchangeably pluggable into the tax return preparation system;
applying the historical tax return data to the one or more analytics modules that are selected for evaluation;
receiving analytics outputs from the one or more analytics modules, in response to applying the historical tax return data; and
determining an effectiveness of each of the one or more analytics modules by correlating the analytics outputs with at least part of the historical tax return data.

24. The system of claim 23, wherein the process further comprises:
sorting the one or more analytics modules based on the effectiveness of each of the one or more analytics modules; and
providing, for use within the tax return preparation system, one of the one or more analytics modules having a highest effectiveness.

25. The system of claim 23, wherein the effectiveness of each of the one or more analytics modules is associated with a numerical effectiveness score.

26. The system of claim 23, wherein the historical tax return data includes one or more of:
data indicating the user's name;
data indicating the user's Social Security Number;
data indicating the user's government identification;
data indicating the user's a driver's license number;
data indicating the user's date of birth;
data indicating the user's address;
data indicating the user's zip code;
data indicating the user's home ownership status;
data indicating the user's marital status;
data indicating the user's annual income;
data indicating the user's job title;
data indicating the user's employer's address;
data indicating the user's spousal information;
data indicating the user's children's information;
data indicating the user's assets;
data indicating the user's medical history;
data indicating the user's occupation;
data indicating the user's website browsing preferences;
data indicating the user's typical lingering duration on a website;
data indicating the user's dependents;
data indicating the user's salary and wages;
data indicating the user's interest income;
data indicating the user's dividend income;
data indicating the user's business income;
data indicating the user's farm income;
data indicating the user's capital gain income;
data indicating the user's pension income;
data indicating the user's IRA distributions;
data indicating the user's unemployment compensation;
data indicating the user's educator expenses;
data indicating the user's health savings account deductions;
data indicating the user's moving expenses;
data indicating the user's IRA deductions;
data indicating the user's student loan interest deductions;
data indicating the user's tuition and fees;
data indicating the user's medical and dental expenses;
data indicating the user's state and local taxes;
data indicating the user's real estate taxes;
data indicating the user's personal property tax;
data indicating the user's mortgage interest;
data indicating the user's charitable contributions;
data indicating the user's casualty and theft losses;
data indicating the user's unreimbursed employee expenses;
data indicating the user's alternative minimum tax;
data indicating the user's foreign tax credit;
data indicating the user's education tax credits;
data indicating the user's retirement savings contribution;
data indicating the user's child tax credits;
data indicating the user's residential energy credits;
data from the user's 1099 form; and
data from the user's K-1 form.

27. The system of claim 23, wherein the process further comprises:
receiving, with the computing system, user data from the user through a user interface; and
applying a selected one of the one or more analytics modules to the user data to determine a relevance of tax questions to the user,
wherein the selected one of the one or more analytics modules includes a higher effectiveness than another of the one or more analytics modules.

28. The system of claim 23, wherein selecting one or more analytics modules for evaluation includes selecting two analytics modules that are configured to perform a particular function, with two different techniques, to determine which of the two analytics modules more accurately prioritizes tax questions for the user.

29. The system of claim 23, wherein the historical tax return data includes tax return data for other users from a present tax year.

30. The system of claim 23, wherein the historical tax return data includes tax return data for other users from one or more previous tax years.

31. The system of claim 23, wherein the historical tax return data includes synthetic data that has been prepared for the evaluation of the one or more analytics modules.

32. The system of claim 23, wherein the one or more analytics modules are configured to prioritize tax questions and tax topics based on user data.

33. The system of claim 23, wherein the tax return preparation system applies at least some of the one or more analytics modules to user data received from the user during a tax return preparation interview.

34. The system of claim 23, wherein applying the historical tax return data includes applying a sample of the historical tax return data to the one or more analytics modules, to limit evaluation time for the one or more analytics modules.

35. The system of claim 23, wherein applying the historical tax return data to the one or more analytics modules includes applying one or more specific parameters of the historical tax return data to determine the analytics outputs for a particular tax question.

36. The system of claim 23, wherein the historical tax return data includes inflation adjustments so that the historical tax return data corresponds to present currency values.

37. The system of claim 23, wherein each of the one or more analytics modules includes at least one of an algorithm, a predictive model, and a statistical engine.

38. The system of claim 23, wherein the process further comprises:
training one or more of the analytics modules based at least partially on the determined effectiveness of each of the analytics modules.
